(19) United States
(12) Patent Application Publication
(10) Pub. No.: US 2026/0328043 A1
(43) Pub. Date: Oct. 22, 2026

(54) SYSTEM AND METHOD FOR REMOTELY CONTROLLING AT LEAST ONE PIECE OF VEHICLE EQUIPMENT

(71) Applicant: Faurecia Clarion Electronics Europe, Paris (FR)

(72) Inventors: Frederick BOIS, STRASBOURG (FR); Alain NGUYEN, LE PERREUX SUR MARNE (FR); Stéphane DA CRUZ, PARIS (FR); Steve LIEM, ERAGNY SUR OISE (FR)

(21) Appl. No.: 19/554,489

(22) Filed: Mar. 2, 2026

(30) Foreign Application Priority Data
Feb. 28, 2025 (FR) FR 2502036

(51) Int. Cl. E05F 15/73; B60Q 3/225

(52) U.S. Cl. CPC E05F 15/73; B60Q 3/225; E05F 2015/767; E05Y 2900/538

(57) ABSTRACT

A method and system for remotely controlling at least one piece of equipment of a vehicle. The system includes an image sensor configured to capture images of a user and detect a gaze direction of the user, a control device connected to the image sensor and configured to control a movement actuator of the piece of equipment, and a control member manually operable by the user of the vehicle. The control device is configured to: determine a target piece of equipment based on a user gaze direction provided by the image sensor; receive validation from the user, the validation being carried out by a first actuation of the control member; and receive a command from the control member and actuate a movement of the target piece of equipment based on the command, the command being effected by a second actuation of the control member by the user.

### TECHNICAL FIELD

The present invention relates to a system for remotely controlling at least one piece of vehicle equipment, and a vehicle equipped with such a control system.

The invention also relates to a method of remotely controlling at least one piece of vehicle equipment.

The invention is in the field of remote control of certain pieces of motor vehicle equipment which is configured to be moved by an actuator, for a movement such as opening/closing.

### BACKGROUND

In general, vehicles, e.g. motor vehicles, feature a variety of pieces of equipment configured to move between at least two positions, e.g. a storage box lid, door windows that are movable between an open and a closed position, or internal or external mirrors that are movable along multiple axes. Movement is generally controlled manually, by operating the equipment itself or a control button associated with each piece of equipment.

However, at least some pieces of equipment of this type can be located at a distance from a user, in particular from the vehicle driver when the latter is in the driving position, the distance typically being greater than an arm's length. Thus, actuating such a piece of equipment, for example opening a storage box with a lid, involves movement of the driver toward the equipment.

There is a need to improve ergonomics by making it easier to remotely control a piece of vehicle equipment in order to move it.

### SUMMARY

To this end, an object of the invention is a system for remotely controlling at least one piece of vehicle equipment, comprising an image sensor configured to capture images of a vehicle user and detect a gaze direction of said user, a control device connected to said image sensor, said control device being configured to control a movement actuator of said piece of equipment, the remote control system further comprising a control member manually operable by the vehicle user. This control device is configured to:
determine a target piece of equipment based on a user gaze direction provided by the image sensor;
receive validation from the user, said validation being carried out by a first actuation of the control member,
receive a command from the control member and actuate a movement of said target piece of equipment based on said command, said command being effected by a second actuation of the control member by the user.

Advantageously, the use of the direction of the user's gaze combined with the use of the control member allows easy and ergonomic control of the movement, via the control member, of any target piece of equipment of the vehicle.

According to other advantageous aspects of the invention, the control system comprises one or more of the following features, taken alone or in any technically feasible combination.

The vehicle having a steering wheel, wherein said control member is disposed on said steering wheel or at a distance of less than 50 cm from said steering wheel.

The target piece of equipment is configured to be moved between an open position and a closed position.

The control member is a rotary pushbutton.

The first actuation is a press on said rotary pushbutton.

The second actuation is a rotation of said rotary pushbutton, the direction of rotation defining a direction of movement of said target piece of equipment.

The system further comprises at least one light source, the control device being configured to control said light source to illuminate the target piece of equipment after receiving the first actuation of the control member.

The light source comprises one or more light-emitting diodes.

The invention also relates to a method of controlling at least one piece of vehicle equipment, implemented by a control system comprising an image sensor configured to capture images of a vehicle user and detect a gaze direction of said user, a control device connected to said image sensor, said control device being configured to control a movement actuator of said piece of equipment, the system further comprising a control member manually operable by the vehicle user, the method being implemented by said control device and comprising steps of:
determining a target piece of equipment based on a user gaze direction provided by the image sensor;
receive validation from the user, said validation being carried out by a first actuation of the control member
receiving a command from the control member and actuating a movement of said target piece of equipment based on said command, said command being effected by a second actuation of the control member by the user.

The invention also relates to a computer program comprising software instructions which, when executed by a computer, implement a method of remotely controlling at least one piece of vehicle equipment, as defined above.

### BRIEF DESCRIPTION OF THE DRAWINGS

The invention will become clearer on reading the following description, given solely by way of non-limiting example, and made with reference to the drawings, wherein:

FIG. 1 is a schematic view of part of a vehicle interior wherein a remote control system is installed;

FIG. 2 is an overview of a remote control system according to one embodiment;

FIG. 3 schematically shows a spatial map of controllable pieces of equipment, and

FIG. 4 is a block diagram of the main steps of a method of remote control according to one embodiment.

### DETAILED DESCRIPTION

The invention is applicable to any type of vehicle, in particular a transport vehicle, such as a car or bus.

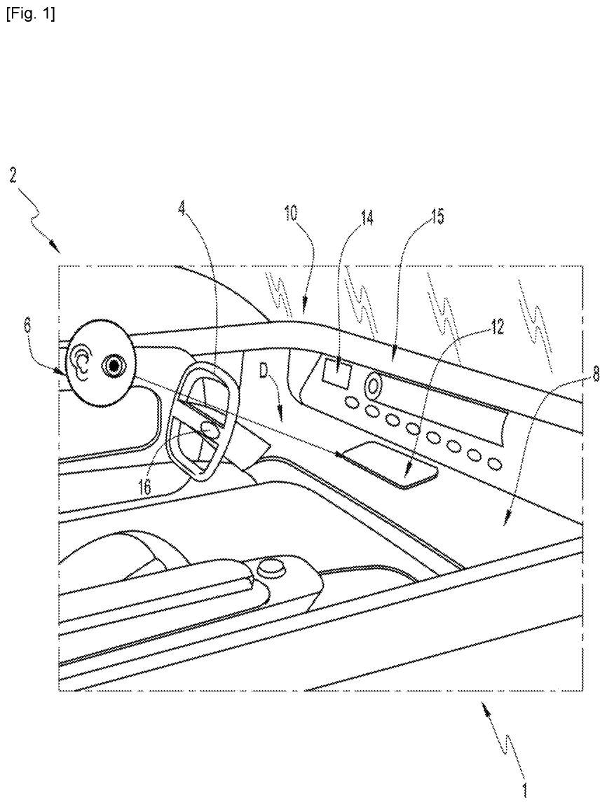

FIG. 1 schematically shows a passenger compartment 2 of a motor vehicle 1.

The vehicle 1 features a steering wheel 4.

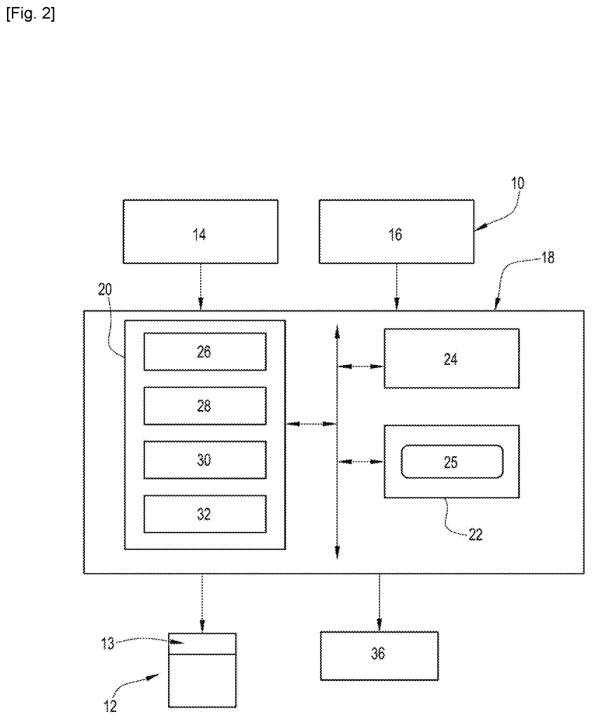

FIG. 2 schematically shows a user 6 of the vehicle 1, the user 6 being the driver of the vehicle 1, seated in a driving position behind the steering wheel 4. It should be noted that the invention also applies to any other user of the vehicle, such as a passenger.

The vehicle also features a dashboard 8, in which a storage box with a lid 12 is arranged, which can be moved between an open and a closed position by an actuator 13 (visible in FIG. 2). The lid 12 is an example of a piece of equipment that can be moved by a remote control system 10, hereinafter referred to simply as control system 10, as described in greater detail below with reference to FIG. 2.

The control system 10 is configured to control a plurality of pieces of equipment 12, which can be moved by an actuator between at least two positions, such as a storage box lid, a vehicle window, a vehicle side mirror, vehicle air vents, lighting devices (e.g. a reading light). The list is provided by way of example and is not exhaustive.

The control system 10 includes an image sensor 14 configured to capture images of a vehicle user and detect a direction D of the user's gaze.

For example, the image sensor 14 is a DMS (“Driver Monitoring System”), integrated for example in the dashboard 8, or in an instrument panel 15 of the vehicle, or in the steering wheel 4. The image sensor 14 is conveniently positioned opposite the vehicle's driving position, so as to capture images of the vehicle driver and calculate the direction D of the driver's gaze, for example in the form of a 3D vector in a chosen spatial reference frame.

Alternatively, the image sensor 14 is an OMS (Occupant Monitoring System) configured to sense the gaze direction of another vehicle occupant.

In a variant not shown, an additional image sensor is used to improve gaze direction accuracy, for example a camera located in the center of the dashboard or at the central rearview mirror.

The control system 10 further comprises a control member 16 that can be manually actuated by the user 6.

The control member 16 is, for example, a rotary pushbutton.

The control member 16 is preferably located in an area that can be easily reached by the vehicle user 6.

For example, when the user 6 in question is the vehicle driver, the control member 16 is preferably located on the steering wheel 4 or close to the steering wheel 4, that is to say at a distance less than or equal to 50 cm from the steering wheel 4, preferably less than 30 cm, so that it can be easily manipulated by the driver 6, without the need to lean over.

The control system 10 further comprises a control device 18, connected to the image sensor 14 and the control member 16, for example via bidirectional wired or wireless communication interfaces.

The control device 18 forms a programmable electronic device comprising a computing processor 20, an electronic memory unit 22 and communication interface units 24, linked by an internal communication bus 25.

The control device 18 is configured to control the actuation of one or more pieces of equipment 12, each piece of equipment 12 having an actuator 13 for moving the piece of equipment between at least two positions, for example an open position and a closed position in the case of a lid or window. For example, the control device 18 is configured to transmit commands via a communication link to each actuator 13 of a piece of equipment 12.

The communication interface unit 24 can comprise a plurality of modules for interfacing respectively with the image sensor 14, the control member 16 and each actuator 13 of a piece of equipment 12.

The control device 18 comprises a determination module 26, a validation module 28, an optional lighting module 30 and a control module 32, described in greater detail below, configured to cooperate to implement a method of remotely controlling a piece of equipment 12.

In one embodiment, the modules 26, 28, 30 and 32 are made in the form of software instructions forming a computer program, which, when executed by a computer, implements a control method according to the invention.

The computer program comprising software instructions is furthermore able to be recorded on a non-transitory computer-readable medium. The computer-readable medium is for example a medium able to store the electronic instructions and to be coupled to a bus of a computer system. As an example, the readable medium is an optical disc, a magneto-optical disc, a ROM memory, a RAM memory, any type of non-volatile memory (for example EPROM, EEPROM, FLASH, NVRAM), a magnetic card or an optical card.

In a variant not shown, the modules 26, 28, 30, 32 are each made in the form of programmable logic components, such as FPGAs (Field-Programmable Gate Arrays), microprocessors, GPGPU (General-Purpose Processing on Graphics Processing) components, or dedicated integrated circuits, such as ASICs (Application-Specific Integrated Circuits).

The determination module 26 is configured to determine a target piece of equipment 12 based on a user gaze direction provided by the image sensor.

In one embodiment, a map 25 representative of the movable controllable pieces of equipment 12 is used in relation to the gaze direction D, an intersection between the gaze direction and the map 25 being used to determine the target piece of equipment.

The validation module 28 is configured to receive validation from the user, this validation being carried out by a first actuation of the control member. In other words, a first signal, referred to as validation signal, is received from the control member 16.

For example, when the control member 16 is a pushbutton, the first actuation is a press (or “click”) on the button.

Thus, by this first actuation of the control member, the user indicates the target piece of equipment.

Optionally, the vehicle 1 also includes one or more light sources 36, controllable by the control device 18, is arranged to selectively illuminate the or each piece of equipment 12 with a light pattern. These light sources are, for example, light-emitting diodes, such as light-emitting diode arrays, which can be controlled independently or in blocks.

Alternatively, each piece of equipment 12 is associated with a light source 36, such as a LED indicator light. The various indicator lights 36 can also be controlled by the control device 18.

Optionally, the lighting control module 30 is configured to control the light source(s) 36 to illuminate the specified target piece of equipment.

Advantageously, this provides a visual indication to the user of the target piece of equipment determined, allowing the user to ensure that the target piece of equipment is the one he wishes to choose.

The control module 32 is configured to receive a command from the control member and actuate a movement of the target piece of equipment based on the command, this command being effected by a second actuation of the control member.

For example, when the control member is a rotary pushbutton, the second actuation is a rotation, the direction of rotation then indicating a selected direction of movement of the target piece of equipment.

Alternatively, the second actuation can be a prolonged press on the pushbutton, with release of the pushbutton stopping the movement of the target piece of equipment.

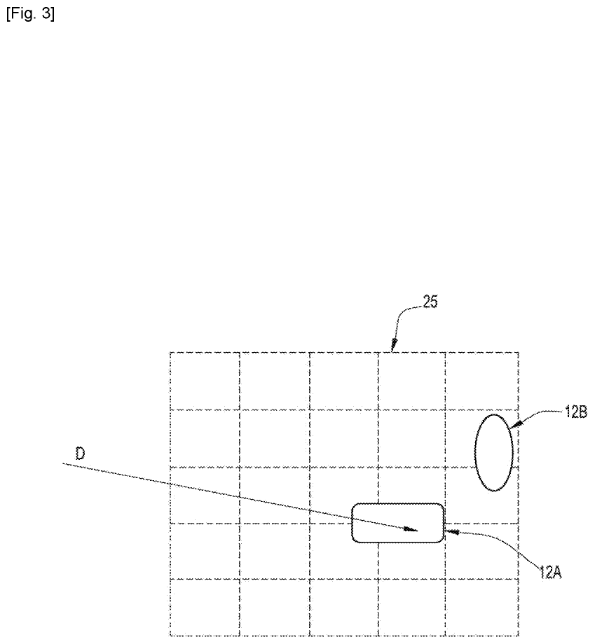

FIG. 3 schematically shows a map 25 showing two controllable pieces of equipment 12A, 12B, the map being gridded into cells. The direction D of the user's gaze indicates a grid cell, and the nearest piece of equipment identified on the map 25, which is piece of equipment 12A in FIG. 3, is selected as the target piece of equipment.

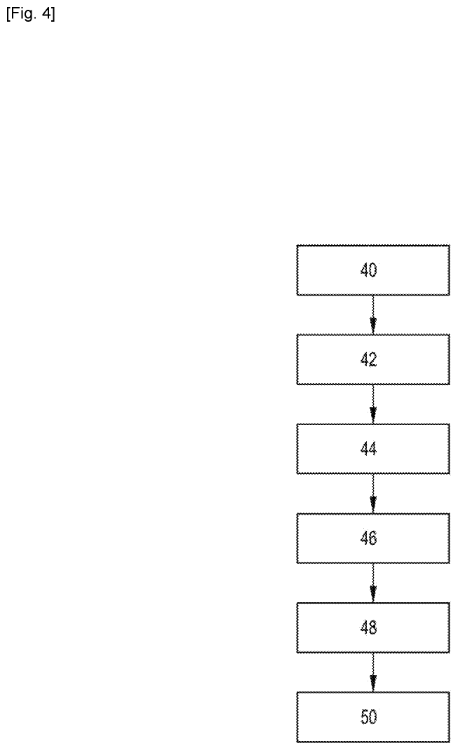

FIG. 4 is a block diagram of the main steps of a method of remotely controlling at least one piece of vehicle equipment.

The method is implemented by a control system 10 as described above.

The control method comprises a step 40 to initialize the method and receive the user's gaze direction, for example in the form of a 3D vector in a predetermined spatial reference frame.

Optionally, initialization 40 is implemented by a predetermined action of the user on the control member, for example a double-click. Alternatively, if the vehicle is equipped with a voice command recognition system, initialization could be performed by voice command.

The method further comprises a step 42 to determine a target piece of equipment based on the gaze direction. For example, a map 25 is used in this step, and a grid cell intersected by the gaze direction is detected, and the piece of equipment contained, at least partially, in this cell is chosen as the target piece of equipment.

The method then comprises receiving 44 a validation from the user. The user performs the validation by a first actuation of the control member, for example a click, which results in the emission of a first signal, which is received by the control device.

Optionally, the method includes a step 46 to illuminate the target piece of equipment, providing a visual indication for the user to confirm the selection.

When this step 46 is carried out, the user receives visual feedback to confirm that the piece of equipment to be operated by the system is the one he wishes to operate.

When the selected piece of equipment is validated, the method further includes a step 48 for receiving a command from the control member, effected by a second actuation of the control member by the user. In other words, the user performs a second actuation of the control member, for example a rotation, which results in the emission of a second signal, received by the control device.

The command received from the control member is transformed into a command to move the target piece of equipment.

For example, rotation of the control member in a first direction opens a storage box lid. For example, rotation of the control member in a second direction, opposite the first direction, closes a storage box lid.

The method then comprises, in one embodiment, a remote control method output 50.

According to one variant, the output 50 of the remote control method is performed by the user applying a predetermined action to the control member, such as a double-click or the like. Alternatively, if the vehicle is equipped with a voice command recognition system, output could be performed by voice command.

The method described above allows the control member to be paired with a target piece of equipment determined by the direction of the user's gaze, the control member then being configured to remotely control the chosen piece of equipment.

Advantageously, when the control member is positioned proximate to the user, e.g. the driver, this makes it easy to control various pieces of equipment remotely, which is more comfortable and reduces the risk of accidents. This thus results in improved driving safety.

1. A control system for remotely controlling at least one piece of equipment of a vehicle, comprising an image sensor configured to capture images of a vehicle user and detect a gaze direction of said user, a control device connected to said image sensor, said control device being configured to control a movement actuator of said piece of equipment, the control system further comprising a control member manually operable by the user of the vehicle, the control device being configured to:
determine a target piece of equipment based on a user gaze direction provided by the image sensor;
receive validation from the user, said validation being carried out by a first actuation of the control member, and
receive a command from the control member and actuate a movement of said target piece of equipment based on said command, said command being effected by a second actuation of the control member by the user.

2. The control system according to claim 1, the vehicle having a steering wheel, wherein said control member is disposed on said steering wheel or at a distance of less than 50 cm from said steering wheel.

3. The control system according to claim 1, wherein said target piece of equipment is configured to be moved between an open position and a closed position.

4. The control system according to claim 1, wherein the control member is a rotary pushbutton.

5. The control system according to claim 4, wherein the first actuation is a press on said rotary pushbutton.

6. The control system according to claim 4, wherein the second actuation is a rotation of said rotary pushbutton, the direction of rotation defining a direction of movement of said target piece of equipment.

7. The control system according to claim 1, further comprising at least one light source, the control device being configured to control said light source to illuminate the target piece of equipment after receiving the first actuation of the control member.

8. The control system according to claim 7, wherein said light source comprises one or more light-emitting diodes.

9. A method of controlling at least one piece of vehicle equipment, implemented by a remote control system comprising an image sensor configured to capture images of a vehicle user and detect a gaze direction of said user, a control device connected to said image sensor, said control device being configured to control a movement actuator of said piece of equipment, the control system further comprising a control member manually operable by the vehicle user, the method being implemented by said control device and comprising steps of:
determining a target piece of equipment based on a user gaze direction provided by the image sensor;
receiving validation from the user, said validation being effected by a first actuation of the control member; and
receiving a command from the control member and actuating a movement of said target piece of equipment based on said command, said command being effected by a second actuation of the control member by the user.

10. A vehicle comprising the control system according to claim 1.
